(19) United States
(12) Patent Application Publication
(10) Pub. No.: US 2025/0320081 A1
(43) Pub. Date: Oct. 16, 2025

(54) SCANNER WITH AN AUTOMATIC EXPANDING OUTPUT TRAY

(71) Applicant: Foxlink Image Technology Co., Ltd., New Taipei City (TW)

(72) Inventors: Yung Wen Lee, New Taipei City (TW); Yen Ya Wu, New Taipei City (TW)

(21) Appl. No.: 18/906,223

(22) Filed: Oct. 4, 2024

(30) Foreign Application Priority Data
Apr. 12, 2024 (CN) 202420764926.7

(51) Int. Cl. B65H 43/00; B65H 31/20; H04N 1/00

(52) U.S. Cl. CPC B65H 43/00; B65H 31/20; H04N 1/00535; B65H 2301/42124; B65H 2402/54; B65H 2555/10; B65H 2801/39

(57) ABSTRACT

A scanner with the automatic expanding output tray includes a mechanical body, a first output tray, a second output tray, an extending output tray, an extending torsion spring, a limiting element and a unidirectional actuator. The first output tray has a starting end pivotally connected to a rear of the mechanical body, and a connecting end. The second output tray has a pivoting end pivoted at the connecting end, and a terminal end. The extending output tray is pivotally connected to the second output tray. The extending torsion spring is mounted between the extending output tray and the second output tray. The limiting element is pivotally connected to the second output tray. The unidirectional actuator is mounted between the limiting element and the first output tray.

### CROSS REFERENCE TO RELATED APPLICATIONS

The present application is based on, and claims priority from, China Patent Application No. 202420764926.7, filed Apr. 14, 2024, the disclosure of which is hereby incorporated by reference herein in its entirety.

### BACKGROUND OF THE INVENTION

### Field of the Invention

The present invention generally relates to a scanner with a foldable output tray, and more particularly to a scanner with an automatic expanding output tray.

### Description of Related Art

In order to facilitate scanning a large quantity of documents by a user, a conventional scanner is equipped with an input tray to hold the documents which are to be fed into the conventional scanner, and an output tray for holding the documents which are to be fed out. Simultaneously, in order to minimize a size of the conventional scanner and make the conventional scanner easier to be carried, the input tray and the output tray are often designed to be foldable structures.

The conventional scanner includes a mechanical body, and the output tray pivotally connected to a rear of the mechanical body. In order to minimize the overall size of the conventional scanner when the conventional scanner is folded, the output tray includes a first output tray pivotally connected to one side of the mechanical body, a second output tray pivotally connected to a tail end of the first output tray, and an extending output tray movably mounted in the second output tray to be pulled out of the second output tray. When the first output tray, the second output tray and the extending output tray are fully expanded, the scanned documents are fed out to the output tray for being temporarily stored.

However, when the output tray is opened or folded, the user has to manually adjust positions of the first output tray, the second output tray and the extending output tray one by one, so when the user uses the conventional scanner actually, the user easily starts scanning the documents directly under a condition of incompletely opening the output tray. As a result, a document damage is caused.

Therefore, it is necessary to provide an innovative scanner with an automatic expanding output tray.

### BRIEF SUMMARY OF THE INVENTION

An object of the present invention is to provide a scanner with an automatic expanding output tray, comprising: a mechanical body; a first output tray having a starting end pivotally connected to a rear of the mechanical body, and a connecting end which is able to swing freely; a second output tray having a pivoting end pivotally connected to the connecting end, and a terminal end which is able to swing freely; an extending output tray pivotally connected to the second output tray to make the extending output tray movable with the second output tray, the first output tray, the second output tray and the extending output tray being able to be folded to the rear and a top of the mechanical body, and the first output tray, the second output tray and the extending output tray being expanded to form an output tray; an extending torsion spring mounted between the extending output tray and the second output tray to exert a rotation torque on the extending output tray, and the rotation torque which is exerted on the extending output tray driving the extending output tray to be ejected out from the second output tray; a limiting element pivotally connected to the second output tray for fastening the extending output tray or releasing the extending output tray when the limiting element is driven, a pivoting axis direction of the limiting element being perpendicular to an outer surface and an inner surface of the second output tray; and a unidirectional actuator mounted between the limiting element and the first output tray, in a process of expanding the first output tray and the second output tray, the first output tray pushing against the unidirectional actuator to rotate forward to drive the limiting element to release the extending output tray, and in a process of folding the first output tray and the second output tray, the first output tray pushing against the unidirectional actuator to rotate reversely to drive the limiting element to fasten the extending output tray.

Another object of the present invention is to provide a scanner with an automatic expanding output tray, comprising: a mechanical body; a first output tray having a starting end pivotally connected to a rear of the mechanical body, and a connecting end which is able to swing freely; a second output tray having a pivoting end pivotally connected to the connecting end, and a terminal end which is able to swing freely, the second output tray having a containing slot recessed inward in a middle of an outer surface of the second output tray, the terminal end defining an inserting hole penetrating through an outer surface and an inner surface of the terminal end, the inserting hole being communicated with the containing slot; an extending output tray pivotally connected to the second output tray to make the extending output tray movable with the second output tray, the first output tray, the second output tray and the extending output tray being able to be folded to the rear and a top of the mechanical body, and the first output tray, the second output tray and the extending output tray being expanded to form an output tray; an extending torsion spring mounted between the extending output tray and the second output tray to exert a rotation torque on the extending output tray, and the rotation torque which is exerted on the extending output tray driving the extending output tray to be ejected out from the second output tray; a limiting element pivotally connected to the second output tray, a pivoting axis direction of the limiting element being perpendicular to an pivoting axis between the first output tray and the second output tray; and a unidirectional actuator mounted between the limiting element and the first output tray, in a process of expanding the first output tray and the second output tray, the first output tray pushing against the unidirectional actuator to rotate forward to drive the limiting element to release the extending output tray, and in a process of folding the first output tray and the second output tray, the first output tray pushing against the unidirectional actuator to rotate reversely to drive the limiting element to fasten the extending output tray, wherein when the output tray is folded to the scanner with the automatic expanding output tray or the output tray is unfolded from the scanner with the automatic expanding output tray, the extending output tray rotates into the containing slot of the second output tray through the inserting hole or the extending output tray is ejected out from the inserting hole.

Another object of the present invention is to provide a scanner with an automatic expanding output tray, comprising: a mechanical body; a first output tray having a starting end pivotally connected to a rear of the mechanical body, and a connecting end; a second output tray having a pivoting end pivotally connected to the connecting end, and a terminal end; an extending output tray pivotally connected to the second output tray to make the extending output tray movable with rotation of the second output tray, the first output tray, the second output tray and the extending output tray being able to be folded to the rear and a top of the mechanical body, and the first output tray, the second output tray and the extending output tray being expanded to form an output tray, a bottom of the extending output tray having a retaining hook; an extending torsion spring mounted between the extending output tray and the second output tray to exert a rotation torque on the extending output tray, and the rotation torque which is exerted on the extending output tray driving the extending output tray to be ejected out from the terminal end of the second output tray; a limiting element pivotally connected to the second output tray, a pivoting axis direction of the limiting element being perpendicular to a pivoting axis between the first output tray and the second output tray, a free end of an outer surface of the limiting element protruding towards the retaining hook of the second output tray to form a limiting hook; and a unidirectional actuator mounted between the limiting element and the first output tray, the unidirectional actuator having a rotation axis being parallel with the pivoting axis between the first output tray and the second output tray, wherein in a process of expanding the first output tray and the second output tray, the first output tray pushes against the unidirectional actuator to rotate forward to drive the limiting element to make the retaining hook apart away from the limiting hook to release the extending output tray, and in a process of folding the first output tray and the second output tray, the first output tray pushes against the unidirectional actuator to rotate reversely to drive the limiting element to make the retaining hook buckled with the limiting hook to fasten the extending output tray.

As described above, the scanner with the automatic expanding output tray includes the mechanical body, the first output tray which has the starting end pivotally connected to the rear of the mechanical body, and the connecting end which is able to swing freely, the second output tray has the pivoting end pivoted at the connecting end, and the terminal end which is able to swing freely, the extending output tray pivotally connected to the second output tray, the extending torsion spring is mounted between the extending output tray and the second output tray to exert the rotation torque on the extending output tray, and the rotation torque which is exerted on the extending output tray drives the extending output tray to rotate towards the inserting hole to be ejected out from the second output tray, the limiting element movably mounted to the second output tray for fastening the extending output tray or releasing the extending output tray when the limiting element is driven. Furthermore, an axis direction of a hook ring of the limiting element is perpendicular to the outer surface and the inner surface of the second output tray, and the unidirectional actuator is mounted between the limiting element and the first output tray, so when the first output tray and the second output tray are expanded, the limiting element is driven by the unidirectional actuator and the first output tray to release the extending output tray, and the first output tray and the second output tray are folded, the limiting element is prevented from being driven. As a result, the extending output tray of the scanner with the automatic expanding output tray is expanded automatically by a function of the unidirectional actuator.

### BRIEF DESCRIPTION OF THE DRAWINGS

The present invention will be apparent to those skilled in the art by reading the following description, with reference to the attached drawings, in which:

FIG. 1 is a perspective view of a scanner with an automatic expanding output tray, wherein an output tray of the scanner with the automatic expanding output tray is folded according to the present invention;

FIG. 2 is a perspective view of the scanner with the automatic expanding output tray, wherein the output tray of the scanner with the automatic expanding output tray is expanded according to the present invention;

FIG. 3 is a perspective view of a first output tray of the scanner with the automatic expanding output tray according to the present invention;

FIG. 4 is an exploded view of a second output tray of the scanner with the automatic expanding output tray according to the present invention;

FIG. 5 is a perspective view of an unidirectional actuator of the scanner with the automatic expanding output tray according to the present invention;

FIG. 6 is a sectional diagram of the unidirectional actuator and the second output tray of the scanner with the automatic expanding output tray according to the present invention;

FIG. 7 is a partial perspective view of the first output tray of the scanner with the automatic expanding output tray in accordance with the present invention;

FIG. 8 is a sectional diagram of the expanded output tray in accordance with the present invention;

FIG. 9 is a schematic diagram of an expanding process of the output tray in accordance with the present invention;

FIG. 10 is a sectional diagram of the folded output tray in accordance with the present invention; and

FIG. 11 is a schematic diagram of a folding process of the output tray in accordance with the present invention.

### DETAILED DESCRIPTION OF THE INVENTION

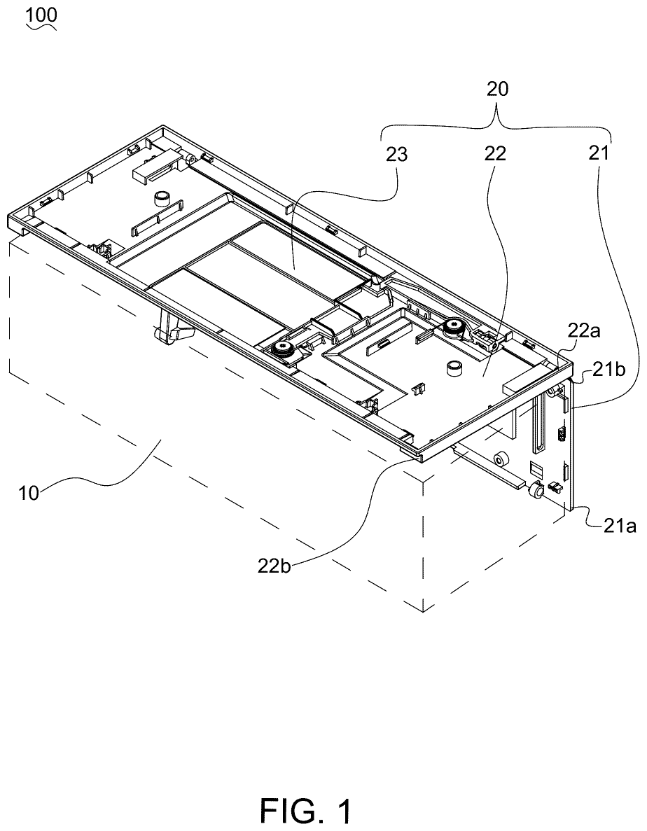

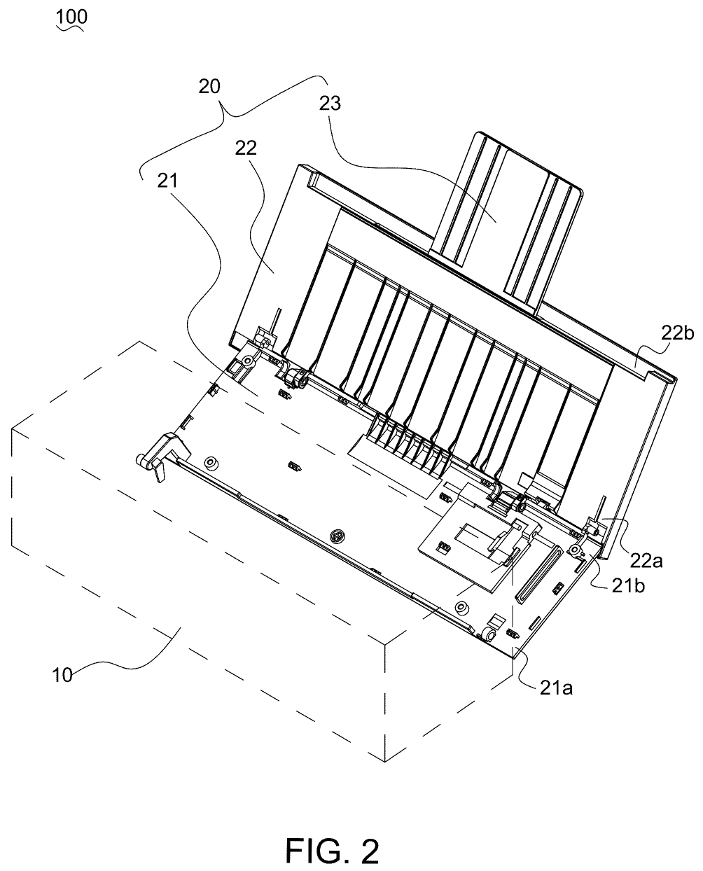

Referring to FIG. 1 and FIG. 2, a scanner with an automatic expanding output tray 100 in accordance with the present invention is shown. The scanner with the automatic expanding output tray 100 includes a mechanical body 10 and an output tray 20. The output tray 20 includes a first output tray 21, a second output tray 22 and an extending output tray 23.

The first output tray 21 has a starting end 21a pivotally connected to a rear of the mechanical body 10, and a connecting end 21b which is able to swing freely. The second output tray 22 has a pivoting end 22a pivoted at the connecting end 21b, and a terminal end 22b which is able to swing freely. The extending output tray 23 is pivotally connected to the second output tray 22 to make the extending output tray 23 movable with the second output tray 22. The first output tray 21, the second output tray 22 and the extending output tray 23 are able to be folded to the rear and a top of the mechanical body 10, and the first output tray 21, the second output tray 22 and the extending output tray 23 are expanded to form the output tray 20 for loading scanned documents when the scanner with the automatic expanding output tray 100 starts scanning the documents.

For a convenient illustration and a convenient description, a direction of the scanner with the automatic expanding output tray 100 in the description is defined as follows. An inside of the output tray 20 mentioned later is in contact with the documents when the first output tray 21 and the second output tray 22 are expanded, and the inside of the output tray 20 is in contact with the mechanical body 10 when the first output tray 21 and the second output tray 22 are folded. An inside of the scanner with the automatic expanding output tray 100 and the inside of the output tray 20 face towards the same direction. The scanner with the automatic expanding output tray 100 is positioned on a desktop. An outside of the output tray 20 mentioned later faces towards the desktop when the first output tray 21 and the second output tray 22 are expanded, and the outside of the output tray 20 faces opposite to the mechanical body 10 when the first output tray 21 and the second output tray 22 are folded.

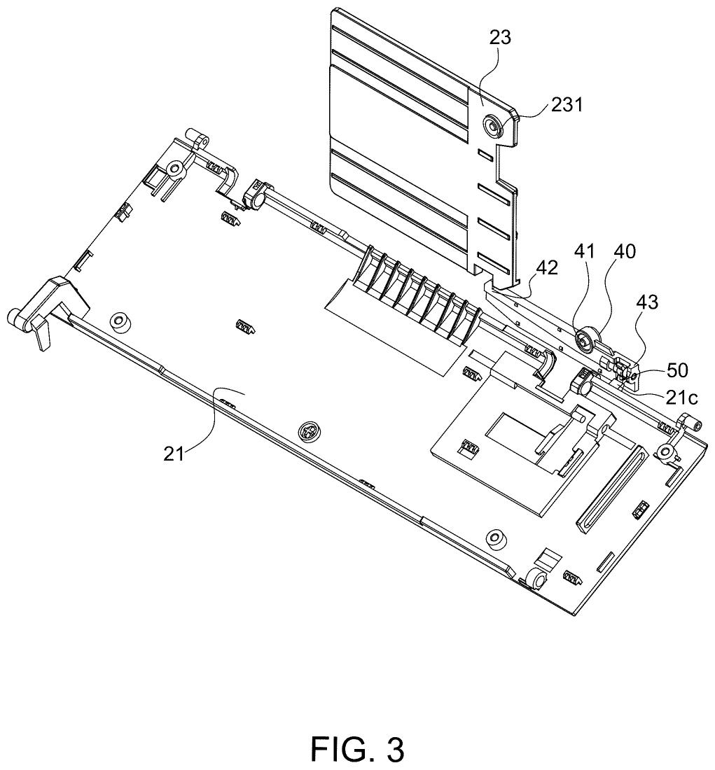

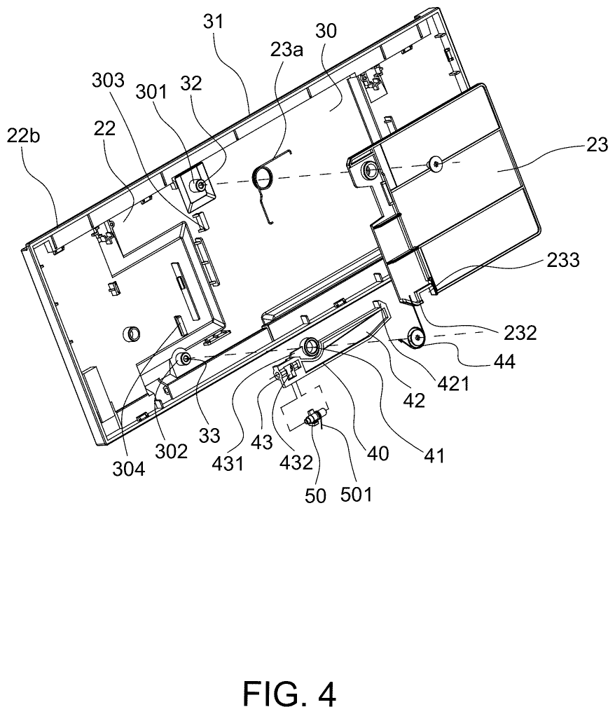

Referring to FIG. 2, FIG. 3 and FIG. 4, the second output tray 22 has a containing slot 30 recessed inward in a middle of an outer surface of the second output tray 22. The containing slot 30 extends towards the terminal end 22b of the second output tray 22 to form an inserting hole 31 at the terminal end 22b of the second output tray 22 and penetrating through an outer surface of the terminal end 22b of the second output tray 22. The terminal end 22b of the second output tray 22 defines the inserting hole 31 penetrating through the outer surface and an inner surface of the terminal end 22b of the second output tray 22. The inserting hole 31 is communicated with the containing slot 30. When the output tray 20 is folded to the scanner with the automatic expanding output tray 100 or the output tray 20 is unfolded from the scanner with the automatic expanding output tray 100, the extending output tray 23 rotates into the containing slot 30 of the second output tray 22 through the inserting hole 31 or the extending output tray 23 is ejected out from the inserting hole 31 of the second output tray 22.

A middle of an inner wall of the containing slot 30 adjacent to the terminal end 22b of the second output tray 22 protrudes outward to form a hollow protruding pillar 301. The middle of the inner wall of the containing slot 30 protrudes outward to form a blocking portion 303. The blocking portion 303 is shown as an L shape. The protruding pillar 301 is located between the terminal end 22b of the second output tray 22 and the blocking portion 303. A middle of the hollow protruding pillar 301 has a shaft hole 32 penetrating through an outer surface of the protruding pillar 301. The protruding pillar 301 together with the shaft hole 32 is located in the containing slot 30, and the protruding pillar 301 together with the shaft hole 32 is arranged close to the inserting hole 31. The protruding pillar 301 and the shaft hole 32 are formed perpendicular to the second output tray 22 for pivotally connecting with the extending output tray 23.

The scanner with the automatic expanding output tray 100 further includes an extending torsion spring 23a. The extending torsion spring 23a is mounted between the extending output tray 23 and the second output tray 22 to exert a rotation torque on the extending output tray 23, and the rotation torque which is exerted on the extending output tray 23 drives the extending output tray 23 to rotate towards the inserting hole 31 to be ejected out from the second output tray 22. One side of the extending output tray 23 has a rotating ring 231 projecting beyond an inner surface and an outer surface of the extending output tray 23. The protruding pillar 301 is inserted into the rotating ring 231. The extending torsion spring 23a is mounted around the rotating ring 231. One free end of the extending torsion spring 23a projects into a mouth of the L-shaped blocking portion 303, and the one free end of the extending torsion spring 23a is blocked by the blocking portion 303. The other free end of the extending torsion spring 23a is blocked by the outer surface of the extending output tray 23.

The second output tray 22 has a hollow pivoting pillar 302 protruded outward from one side of the inner wall of the containing slot 30 of the second output tray 22, and the pivoting pillar 302 of the second output tray 22 is formed next to the pivoting end 22a. A middle of the hollow pivoting pillar 302 has a connecting hole 33 penetrating through an outer surface of the pivoting pillar 302. The connecting hole 33 is formed in one side of the containing slot 30, and the connecting hole 33 is disposed next to the pivoting end 22a. The connecting hole 33 is arranged in the one side of the containing slot 30, and the connecting hole 33 is disposed away from the inserting hole 31. The connecting hole 33 is formed perpendicular to the second output tray 22. One side of the outer surface of the second output tray 22 protrudes outward to form a propping portion 304. The pivoting pillar 302 is located between the propping portion 304 and the pivoting end 22a of the second output tray 22.

The scanner with the automatic expanding output tray 100 further includes a limiting element 40 pivotally connected to the connecting hole 33 of the second output tray 22 for fastening the extending output tray 23 or releasing the extending output tray 23 when the limiting element 40 is driven. The limiting element 40 includes a hook ring 41 rotatably connected to the connecting hole 33, a driving arm 43 extended sideward and away from the extending output tray 23 from one side of the hook ring 41, a hook arm 42 extended sideward and towards the extending output tray 23 from the other side of the hook ring 41, and a resilient torsion spring 44 mounted around the hook ring 41. The hook arm 42 is extended opposite to the driving arm 43. An outer side of the driving arm 43 is recessed inward to form a pivoting groove 432. A middle of the pivoting groove 432 penetrates through an outer surface and an inner surface of the driving arm 43.

An inner portion of the driving arm 43 extends inward to form a buckling portion 431 connected with the one side of the hook ring 41. The pivoting pillar 302 is inserted into the hook ring 41. The resilient torsion spring 44 is mounted between the hook ring 41 and the second output tray 22. One free end of the resilient torsion spring 44 is propped by the propping portion 304, and the other free end of the resilient torsion spring 44 is buckled to the buckling portion 431. The resilient torsion spring 44 exerts a rotation torque on the hook arm 42, and the rotation torque which is exerted on the hook arm 42 drives the hook arm 42 to rotate towards the extending output tray 23.

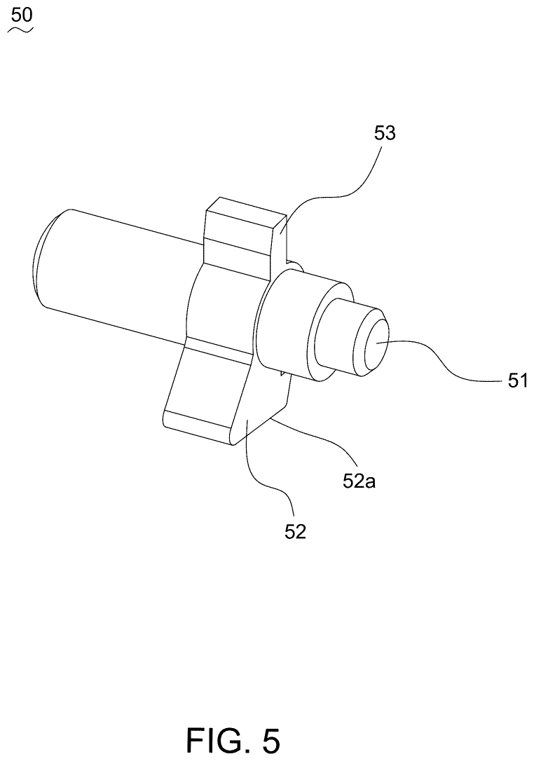

Referring to FIG. 4 and FIG. 5, the scanner with the automatic expanding output tray 100 further includes a unidirectional actuator 50 and an actuating torsion spring 501. The unidirectional actuator 50 is movably pivoted on the driving arm 43. The actuating torsion spring 501 is mounted around the unidirectional actuator 50. The unidirectional actuator 50 is mounted between the limiting element 40 and the first output tray 21. In a process of expanding the first output tray 21 and the second output tray 22, the first output tray 21 pushes against the unidirectional actuator 50 to rotate forward to drive the limiting element 40 to make a retaining hook 232 of the extending output tray 23 apart away from a limiting hook 421 of the limiting element 40 to release the extending output tray 23, and in a process of folding the first output tray 21 and the second output tray 22, the first output tray 21 pushes against the unidirectional actuator 50 to rotate reversely to drive the limiting element 40 to make the retaining hook 232 buckled with the limiting hook 421 to fasten the extending output tray 23. An axis direction of the unidirectional actuator 50 is orthogonal to an axis direction of the hook ring 41 of the limiting element 40. A pivoting axis direction of the limiting element 40 is perpendicular to the outer surface and an inner surface of the second output tray 22.

The unidirectional actuator 50 includes an actuating shaft 51. Two opposite portions of a peripheral surface of the actuating shaft 51 extend oppositely to form an actuating arm 52 and an interlocking arm 53. The actuating shaft 51 is disposed transversely. The actuating arm 52 and the interlocking arm 53 are perpendicular to the actuating shaft 51. The actuating shaft 51 is pivotally connected to the driving arm 43, the actuating shaft 51 is perpendicular to the hook ring 41, the interlocking arm 53 extends towards the driving arm 43 along a radial direction of the actuating shaft 51. The unidirectional actuator 50 is pivotally arranged to the limiting element 40, and the unidirectional actuator 50 is pivotally mounted in the pivoting groove 432. The actuating torsion spring 501 is restricted to the pivoting groove 432. The interlocking arm 53 is disposed adjacent to the limiting element 40.

When the output tray 20 is folded to the scanner with the automatic expanding output tray 100 or the output tray 20 is unfolded from the scanner with the automatic expanding output tray 100, the interlocking arm 53 is apart away from an outer wall of the pivoting groove 432 of the driving arm 43 of the limiting element 40, or the interlocking arm 53 abuts against an inner surface of the outer wall of the pivoting groove 432 of the driving arm 43. The actuating arm 52 is movably disposed in the pivoting groove 432. When the output tray 20 is folded to the scanner with the automatic expanding output tray 100 or the output tray 20 is unfolded from the scanner with the automatic expanding output tray 100, the actuating arm 52 is apart away from an inner wall of the pivoting groove 432 of the limiting element 40, or the actuating arm 52 abuts against an inner surface of the inner wall of the pivoting groove 432.

For the convenient illustration and the convenient description, a rotation direction of the unidirectional actuator 50 of the scanner with the automatic expanding output tray 100 is defined as follows, the rotation direction in which the interlocking arm 53 presses against the inner surface of the outer wall of the pivoting groove 432 of the limiting element 40 is defined as a forward direction. When the unidirectional actuator 50 rotates towards the forward direction, surfaces of the actuating arm 52 and the interlocking arm 53 facing the forward direction of the unidirectional actuator 50 are defined as two positive surfaces, and two surfaces of the actuating arm 52 and the interlocking arm 53 opposite to the forward direction of the unidirectional actuator 50 are defined as two reverse directions.

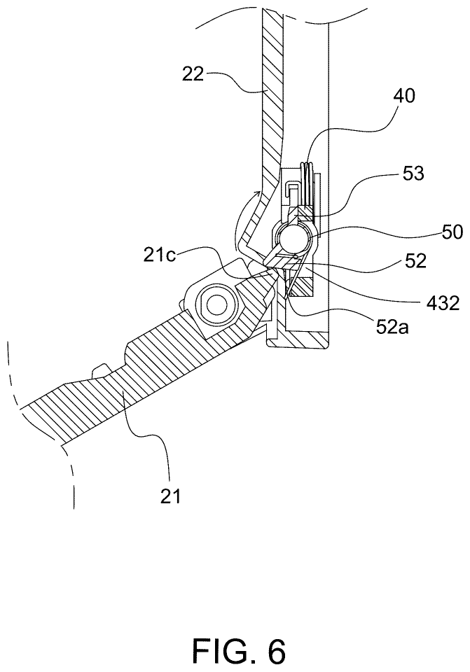

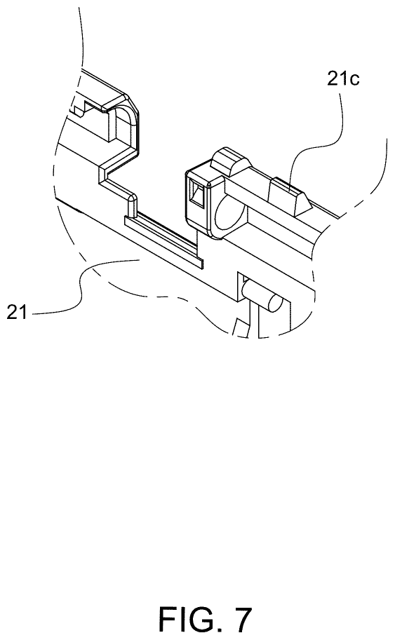

Referring to FIG. 5 to FIG. 7, the reverse surface of the actuating arm 52 is inclined outward and towards the inner surface of the inner wall of the pivoting groove 432 to form an actuating bevel 52a. One side of an outer surface of the connecting end 21b of the first output tray 21 protrudes outward and towards the pivoting end 22a to form a bump 21c. When the second output tray 22 is expanded from the first output tray 21, the bump 21c contacts with the actuating arm 52. When the first output tray 21 and the second output tray 22 are folded, the bump 21c is without contacting the actuating arm 52. An inner end of the extending output tray 23 is recessed inward to form an indentation 233. The inner end of the extending output tray 23 has the retaining hook 232 next to the indentation 233. A free end of an outer surface of the limiting element 40 protrudes towards the terminal end 22b of the second output tray 22 to form the limiting hook 421. A free end of an outer surface of the hook arm 42 perpendicularly protrudes outward to form the limiting hook 421. The retaining hook 232 is buckled with or is apart away from the limiting hook 421. In order to fasten the extending output tray 23, the limiting hook 421 is inserted into the indentation 233, the retaining hook 232 of the extending output tray 23 is interlocked with the limiting hook 421 of the hook arm 42.

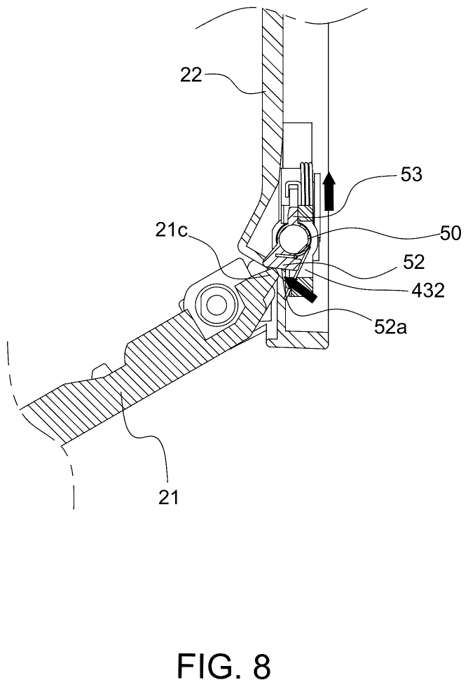

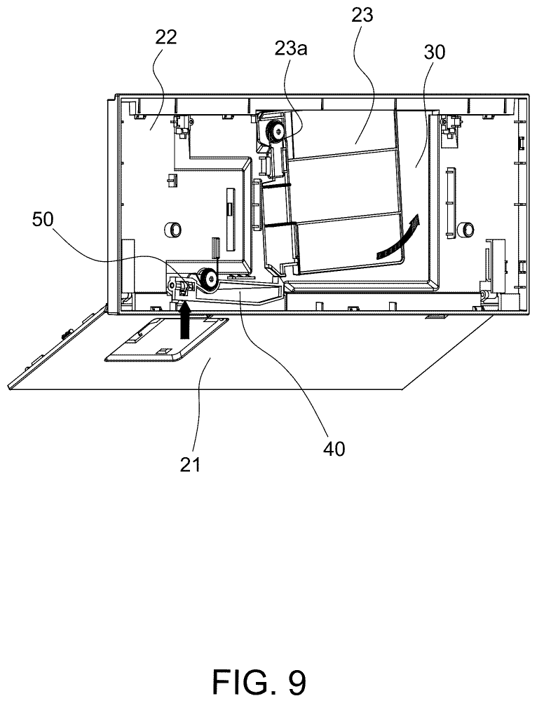

Referring to FIG. 1 to FIG. 9, an expanding process of the output tray 20 is described as follows. When the second output tray 22 is lifted by the user, the bump 21c begins pushing against the actuating bevel 52a, and an action force perpendicular to the actuating bevel 52a is exerted on the actuating arm 52. The action force which is exerted to the unidirectional actuator 50 generates a component force towards the terminal end 22b, and the action force which is exerted to the unidirectional actuator 50 generates a forward torque on the unidirectional actuator 50 which drives the unidirectional actuator 50 to rotate forward. The forward torque on the unidirectional actuator 50 makes the interlocking arm 53 press against the inner surface of the outer wall of the pivoting groove 432 of the limiting element 40, so that the unidirectional actuator 50 is buckled to the limiting element 40, and the unidirectional actuator 50 and the limiting element 40 move together. Then the component force towards the terminal end 22b pushes the actuating arm 52 to swing towards the terminal end 22b, and the hook arm 42 is driven to swing towards the terminal end 22b, so the interlocking arm 53 breaks away from the extending output tray 23, and the limiting hook 421 of the hook arm 42 breaks away from the retaining hook 232 of the extending output tray 23. At the moment, the extending output tray 23 rotates towards the inserting hole 31 under an action of the extending torsion spring 23a, and the extending output tray 23 is ejected out from the inserting hole 31 of the second output tray 22. When the second output tray 22 continues being expanded outward, the bump 21c breaks away from the unidirectional actuator 50, and the hook arm 42 rotates to an original position under an elastic action of the actuating torsion spring 501 and the resilient torsion spring 44.

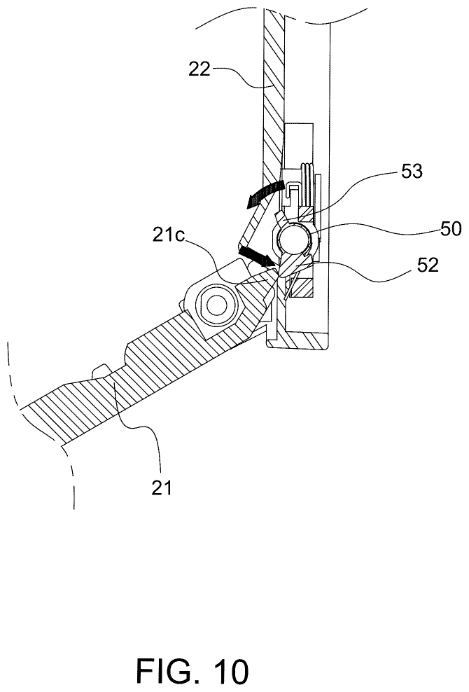

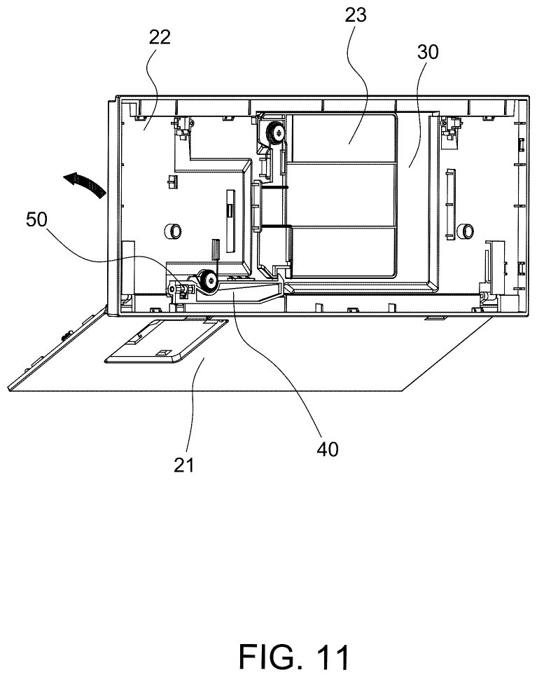

Referring to FIG. 1 to FIG. 11, a folding process of the scanner with the automatic expanding output tray 100 is described as follows. At first, the user retracts the extending output tray 23 into the containing slot 30, and the extending output tray 23 is fastened in the containing slot 30 by means of the retaining hook 232 of the extending output tray 23 being interlocked with the limiting hook 421 of the hook arm 42. Then the user closes the second output tray 22 by sliding the second output tray 22 towards the first output tray 21 and the mechanical body 10, at the moment, an outer portion of the bump 21c begins pushing against the positive surface of the actuating arm 52, the bump 21c exerts a reverse torque on the unidirectional actuator 50, and the reverse torque is opposite to the forward torque. The interlocking arm 53 rotates away from the limiting element 40 under an action of the reverse torque, and the interlocking arm 53 is separated from the limiting element 40, the limiting hook 421 of the hook arm 42 is buckled with the retaining hook 232 of the extending output tray 23, so that when the bump 21c pushes against the unidirectional actuator 50, the interlocking arm 53 is detached from the extending output tray 23. When the second output tray 22 continues being folded towards the mechanical body 10 until the unidirectional actuator 50 completely crosses the bump 21c, the unidirectional actuator 50 rotates to the original position under the elastic action of the actuating torsion spring 501.

As described above, the scanner with the automatic expanding output tray 100 includes the mechanical body 10, the first output tray 21 which has the starting end 21a pivotally connected to the rear of the mechanical body 10, and the connecting end 21b which is able to swing freely, the second output tray 22 has the pivoting end 22a pivoted at the connecting end 21b, and the terminal end 22b which is able to swing freely, the extending output tray 23 pivotally connected to the second output tray 22, the extending torsion spring 23a is mounted between the extending output tray 23 and the second output tray 22 to exert the rotation torque on the extending output tray 23, and the rotation torque which is exerted on the extending output tray 23 drives the extending output tray 23 to rotate towards the inserting hole 31 to be ejected out from the second output tray 22, the limiting element 40 movably mounted to the second output tray 22 for fastening the extending output tray 23 or releasing the extending output tray 23 when the limiting element 40 is driven. Furthermore, the axis direction of the hook ring 41 of the limiting element 40 is perpendicular to the outer surface and the inner surface of the second output tray 22, and the unidirectional actuator 50 is mounted between the limiting element 40 and the first output tray 21, so when the first output tray 21 and the second output tray 22 are expanded, the limiting element 40 is driven by the unidirectional actuator 50 and the first output tray 21 to release the extending output tray 23, and the first output tray 21 and the second output tray 22 are folded, the limiting element 40 is prevented from being driven. As a result, the extending output tray 23 of the scanner with the automatic expanding output tray 100 is expanded automatically by a function of the unidirectional actuator 50.

What is claimed is:

1. A scanner with an automatic expanding output tray, comprising:
a mechanical body;
a first output tray having a starting end pivotally connected to a rear of the mechanical body, and a connecting end which is able to swing freely;
a second output tray having a pivoting end pivotally connected to the connecting end, and a terminal end which is able to swing freely;
an extending output tray pivotally connected to the second output tray to make the extending output tray movable with the second output tray, the first output tray, the second output tray and the extending output tray being able to be folded to the rear and a top of the mechanical body, and the first output tray, the second output tray and the extending output tray being expanded to form an output tray;
an extending torsion spring mounted between the extending output tray and the second output tray to exert a rotation torque on the extending output tray, and the rotation torque which is exerted on the extending output tray driving the extending output tray to be ejected out from the second output tray;
a limiting element pivotally connected to the second output tray for fastening the extending output tray or releasing the extending output tray when the limiting element is driven, a pivoting axis direction of the limiting element being perpendicular to an outer surface and an inner surface of the second output tray; and
a unidirectional actuator mounted between the limiting element and the first output tray, in a process of expanding the first output tray and the second output tray, the first output tray pushing against the unidirectional actuator to rotate forward to drive the limiting element to release the extending output tray, and in a process of folding the first output tray and the second output tray, the first output tray pushing against the unidirectional actuator to rotate reversely to drive the limiting element to fasten the extending output tray.

2. The scanner with the automatic expanding output tray as claimed in claim 1, wherein the second output tray has a containing slot recessed inward in a middle of the outer surface of the second output tray, the containing slot extends towards the terminal end of the second output tray to form an inserting hole at the terminal end of the second output tray and penetrating through an outer surface of the terminal end of the second output tray, a middle of an inner wall of the containing slot adjacent to the terminal end of the second output tray protrudes outward to form a hollow protruding pillar, a middle of the hollow protruding pillar has a shaft hole penetrating through an outer surface of the protruding pillar, the protruding pillar together with the shaft hole is located in the containing slot, and the protruding pillar together with the shaft hole is arranged close to the inserting hole, the protruding pillar and the shaft hole are formed perpendicular to the second output tray, the second output tray has a hollow pivoting pillar protruded outward from one side of the inner wall of the containing slot, and the pivoting pillar is formed next to the pivoting end, a middle of the hollow pivoting pillar has a connecting hole penetrating through an outer surface of the pivoting pillar, the connecting hole is formed in one side of the containing slot, and the connecting hole is disposed next to the pivoting end, the connecting hole is formed perpendicular to the second output tray.

3. The scanner with the automatic expanding output tray as claimed in claim 2, wherein the middle of the inner wall of the containing slot protrudes outward to form a blocking portion, the blocking portion is shown as an L shape, the protruding pillar is located between the terminal end of the second output tray and the blocking portion, one side of the extending output tray has a rotating ring projecting beyond an inner surface and an outer surface of the extending output tray, the protruding pillar is inserted into the rotating ring, the extending torsion spring is mounted around the rotating ring, one free end of the extending torsion spring projects into a mouth of the L-shaped blocking portion, and the one free end of the extending torsion spring is blocked by the blocking portion, the other free end of the extending torsion spring is blocked by the outer surface of the extending output tray.

4. The scanner with the automatic expanding output tray as claimed in claim 2, wherein the limiting element includes a hook ring rotatably connected to the connecting hole, a driving arm extended sideward and away from the extending output tray from one side of the hook ring, a hook arm extended sideward and towards the extending output tray from the other side of the hook ring, and a resilient torsion spring mounted around the hook ring, the resilient torsion spring is mounted between the hook ring and the second output tray, the resilient torsion spring exerts a rotation torque on the hook arm, and the rotation torque which is exerted on the hook arm drives the hook arm to rotate towards the extending output tray.

5. The scanner with the automatic expanding output tray as claimed in claim 4, wherein one side of the outer surface of the second output tray protrudes outward to form a propping portion, the pivoting pillar is located between the propping portion and the pivoting end of the second output tray, an inner portion of the driving arm extends inward to form a buckling portion connected with the one side of the hook ring, the pivoting pillar is inserted into the hook ring, one free end of the resilient torsion spring is propped by the propping portion, and the other free end of the resilient torsion spring is buckled to the buckling portion.

6. The scanner with the automatic expanding output tray as claimed in claim 4, wherein an inner end of the extending output tray has a retaining hook, a free end of an outer surface of the hook arm perpendicularly protrudes outward to form a limiting hook, the retaining hook is buckled with or is apart away from the limiting hook.

7. The scanner with the automatic expanding output tray as claimed in claim 4, wherein an outer side of the driving arm is recessed inward to form a pivoting groove, a middle of the pivoting groove penetrates through an outer surface and an inner surface of the driving arm, the unidirectional actuator is movably pivoted on the driving arm, the scanner with the automatic expanding output tray further includes an actuating torsion spring mounted around the unidirectional actuator, the unidirectional actuator is pivotally mounted in the pivoting groove, the actuating torsion spring is restricted to the pivoting groove.

8. The scanner with the automatic expanding output tray as claimed in claim 7, wherein the unidirectional actuator is pivotally arranged to the limiting element, and the unidirectional actuator is pivotally mounted in the pivoting groove, the unidirectional actuator includes an actuating shaft, two opposite portions of a peripheral surface of the actuating shaft extend oppositely to form an actuating arm and an interlocking arm, the actuating arm and the interlocking arm are perpendicular to the actuating shaft, the actuating shaft is pivotally connected to the driving arm, the actuating shaft is perpendicular to the hook ring, the interlocking arm extends towards the driving arm along a radial direction of the actuating shaft, the interlocking arm is apart away from the driving arm, or the interlocking arm abuts against the driving arm.

9. The scanner with the automatic expanding output tray as claimed in claim 8, wherein when the output tray is folded to the scanner with the automatic expanding output tray or the output tray is unfolded from the scanner with the automatic expanding output tray, the interlocking arm is apart away from an outer wall of the pivoting groove, or the interlocking arm abuts against an inner surface of the outer wall of the pivoting groove, the actuating arm is movably disposed in the pivoting groove, the actuating arm is apart away from an inner wall of the pivoting groove, or the actuating arm abuts against an inner surface of the inner wall of the pivoting groove.

10. The scanner with the automatic expanding output tray as claimed in claim 8, wherein a reverse surface of the actuating arm is inclined outward and towards an inner surface of an inner wall of the pivoting groove to form an actuating bevel, one side of an outer surface of the connecting end of the first output tray protrudes outward and towards the pivoting end to form a bump, when the second output tray is lifted, the bump begins pushing against the actuating bevel, and an action force perpendicular to the actuating bevel is exerted on the actuating arm.

11. A scanner with an automatic expanding output tray, comprising:
a mechanical body;
a first output tray having a starting end pivotally connected to a rear of the mechanical body, and a connecting end which is able to swing freely;
a second output tray having a pivoting end pivotally connected to the connecting end, and a terminal end which is able to swing freely, the second output tray having a containing slot recessed inward in a middle of an outer surface of the second output tray, the terminal end defining an inserting hole penetrating through an outer surface and an inner surface of the terminal end, the inserting hole being communicated with the containing slot;
an extending output tray pivotally connected to the second output tray to make the extending output tray movable with the second output tray, the first output tray, the second output tray and the extending output tray being able to be folded to the rear and a top of the mechanical body, and the first output tray, the second output tray and the extending output tray being expanded to form an output tray;
an extending torsion spring mounted between the extending output tray and the second output tray to exert a rotation torque on the extending output tray, and the rotation torque which is exerted on the extending output tray driving the extending output tray to be ejected out from the second output tray;
a limiting element pivotally connected to the second output tray, a pivoting axis direction of the limiting element being perpendicular to an pivoting axis between the first output tray and the second output tray; and
a unidirectional actuator mounted between the limiting element and the first output tray, in a process of expanding the first output tray and the second output tray, the first output tray pushing against the unidirectional actuator to rotate forward to drive the limiting element to release the extending output tray, and in a process of folding the first output tray and the second output tray, the first output tray pushing against the unidirectional actuator to rotate reversely to drive the limiting element to fasten the extending output tray,
wherein when the output tray is folded to the scanner with the automatic expanding output tray or the output tray is unfolded from the scanner with the automatic expanding output tray, the extending output tray rotates into the containing slot of the second output tray through the inserting hole or the extending output tray is ejected out from the inserting hole.

12. A scanner with an automatic expanding output tray, comprising:
a mechanical body;
a first output tray having a starting end pivotally connected to a rear of the mechanical body, and a connecting end;
a second output tray having a pivoting end pivotally connected to the connecting end, and a terminal end;
an extending output tray pivotally connected to the second output tray to make the extending output tray movable with rotation of the second output tray, the first output tray, the second output tray and the extending output tray being able to be folded to the rear and a top of the mechanical body, and the first output tray, the second output tray and the extending output tray being expanded to form an output tray, a bottom of the extending output tray having a retaining hook;
an extending torsion spring mounted between the extending output tray and the second output tray to exert a rotation torque on the extending output tray, and the rotation torque which is exerted on the extending output tray driving the extending output tray to be ejected out from the terminal end of the second output tray;
a limiting element pivotally connected to the second output tray, a pivoting axis direction of the limiting element being perpendicular to a pivoting axis between the first output tray and the second output tray, a free end of an outer surface of the limiting element protruding towards the retaining hook of the second output tray to form a limiting hook; and
a unidirectional actuator mounted between the limiting element and the first output tray, the unidirectional actuator having a rotation axis being parallel with the pivoting axis between the first output tray and the second output tray,
wherein in a process of expanding the first output tray and the second output tray, the first output tray pushes against the unidirectional actuator to rotate forward to drive the limiting element to make the retaining hook apart away from the limiting hook to release the extending output tray, and in a process of folding the first output tray and the second output tray, the first output tray pushes against the unidirectional actuator to rotate reversely to drive the limiting element to make the retaining hook buckled with the limiting hook to fasten the extending output tray.
